(19) United States
(12) Patent Application Publication
(10) Pub. No.: US 2009/0012763 A1
(43) Pub. Date: Jan. 8, 2009

(54) METHOD AND SYSTEM FOR TIRE EVALUATION AND TUNING WITH LOADING SYSTEM AND VEHICLE MODEL

(75) Inventors: William J. Langer, Minnestrista, MN (US); Randal L. Jenniges, Bloomington, MN (US)

Correspondence Address: MCDERMOTT, WILL & EMERY, 4370 LA JOLLA VILLAGE DRIVE, SUITE 700, SAN DIEGO, CA, 92122, US

(73) Assignee: MTS SYSTEMS CORPORATION, Eden Prairie, MN (US)

(21) Appl. No.: 12/115,426

(22) Filed: May 5, 2008

Related U.S. Application Data
(60) Provisional application No. 60/927,813, filed on May 4, 2007.

(51) Int. Cl. G06G 7/48; G01M 17/02

(52) U.S. Cl. 703/8; 73/146

(57) ABSTRACT

A method and system for evaluating and tuning tires includes a test rig on which one or more physical tires are mounted. A full vehicle model and a road description are used with the test rig to test and evaluate the tire as would be conducted on a real test track. The full vehicle model is modified to remove the characteristics of the tire or tires under test. The remainder of the full vehicle model produces output signals in the form of displacements or loads that are transmitted as inputs to the test rig to apply those signals. The test rig measures output signals in the form of complementary displacements or loads that will become inputs to the vehicle model in place of the removed model of the tire under test. In this manner, the physical tire under test is inserted into a real time model of the full vehicle, road and driver.

### FIELD OF DISCLOSURE

This application generally relates to tire testing and evaluation, and more specifically, to methods and systems for evaluating vehicle tires and their effect on vehicle performance.

### BACKGROUND

Vehicle tires must be evaluated and tested to meet desired vehicle-level performance attributes such as handling, ride, comfort, NVH (noise, harshness, vibration), etc. Today, in order to assess vehicle-level attributes, the vehicle must be driven with the real components installed. This method is costly, slow, and non-repeatable. Also, it typically occurs late in the vehicle development process. Further, engineers might assess the effects of a vehicle on a tire to assess attributes such as tire performance, durability, NVH, etc.

Tires influence vehicle attributes such as ride, comfort and handling. Tires are characterized in testing equipment, but such testing equipment does not directly relate to, or measure, the vehicle response to the given component. Current testing equipment characterizes tires by applying a load or a displacement time history to the tires and measuring resultant loads or displacements. Trailer-based test systems move a real tire over a physical road surface to measure resultant loads or displacements, but similarly do not directly capture vehicle-level effects of the tire.

In the case of a real vehicle on a test track, the evaluation of tire effects on vehicle performance can be direct. The measurement of vehicle performance then depends only on the ability to measure the necessary effects and the repeatability of the test track process. However, in the case of laboratory test rig evaluation of tire performance, either measured time histories or idealized time histories are applied to the tire only. The resulting tire loads or displacements are reduced to engineering terms such as parameter maps, gradients or frequency response functions. The reduced engineering terms of tire performance are used to deduce resultant vehicle behavior through a vehicle model that is applied after the test results are obtained.

The current process of tire characterization and modeling for the purpose of vehicle behavior prediction is limited. The process of fitting the characterization data to the model tends to filter data so the model represents a subset of the complete tire characteristics. This means that it is possible to generate and use an implied tire model that ignores important tire characteristics. This is especially true for those characteristics that may manifest during a dynamic or transient input. Further, the characterization process does not capture changing tire characteristics properly, such as those due to service history or wear. A tire that has characteristics that change depending on service history or un-modeled parameters such as temperature or friction will not be identified in tire measurement systems for inclusion in vehicle behavior prediction. Vehicle evaluation is dependent on many components, including tires. Due to the complex construction and non-linear responses of tires, simulation of tires in a numerical vehicle dynamics model is compromised by the inherently incorrect model of the tires.

Therefore, there is a need to provide a tire evaluation and vehicle simulation process and system that does not rely on an implied model of a tire. Further, there is a need in such a system to account for changing tire characteristics and dynamic tire characteristics that may manifest during a transient input.

### SUMMARY

This and other needs are met by embodiments of the present invention, which provide a system for evaluating tires that comprise a test rig on which at least one tire is mountable, and a vehicle model module. The test rig controllably applies loads on the tire under test. The vehicle model module includes a data processor for processing data, and a data storage device. The data storage device is configured to store: data related to a vehicle model that simulates a full vehicle except for characteristics of the tire under test; data related to a road description; and machine-readable instructions. Upon execution by the data processor, the instructions control the data processor to produce command signals based on the vehicle model to control the test rig to apply loads on the tire and to feed back measured responses of the test rig to the vehicle model. Data from the evaluation may come from the modeled vehicle, the tire, or both.

The foregoing and other features, aspects and advantages of the disclosed embodiments will become more apparent from the following detailed description and accompanying drawings.

### BRIEF DESCRIPTION OF THE DRAWINGS

The present disclosure is illustrated by way of example and not by way of limitation, in the figures of the accompanying drawings and in which like reference numerals refer to similar elements.

FIG. 1 depicts a partially perspective; partially block view of a system for tire evaluation constructed in accordance with certain embodiments of the present invention.

FIG. 2 is a block diagram of the system of FIG. 1, depicting the relationships between components of the system in more detail.

FIG. 3 is a top view of a mounting arrangement and tire positioner for the tire evaluation system of FIG. 1, constructed in accordance with embodiments of the present invention.

FIG. 4 is a side view of the mounting arrangement of FIG. 3.

FIG. 5 is a back view of the mounting arrangement of FIG. 3.

FIG. 6 is a block diagram of a data processor system useable in embodiments of the present invention.

### DETAILED DESCRIPTION

For illustration purposes, the following descriptions describe various illustrative embodiments of testers for evaluating a tire and a vehicle simulation with tire measurements in the loop of a vehicle model. Specific systems and configurations of the test rig are depicted. It will be apparent, however, to one skilled in the art that concepts of the disclosure may be practiced or implemented without these specific details. In other instances, well-known structures and devices are shown in block diagram form in order to avoid unnecessarily obscuring the present disclosure.

Embodiments of the present invention address and solve problems related to the process of tire testing, evaluation or tuning, including that of using an implied tire model, which may ignore important tire characteristics, and does not account for changing tire characteristics or characteristics that might manifest during a transient input. These problems are solved, at least in part, by embodiments of the present invention that provide a system for evaluating tires that comprise a test rig on which at least one tire is mountable, and a vehicle model module. The test rig controllably applies loads on the tire under test. The vehicle model module includes a data processor for processing data, and a data storage device. The data storage device is configured to store: data related to a vehicle model that simulates a full vehicle except for characteristics of the tire under test; data related to a road description; and machine-readable instructions. Upon execution by the data processor, the instructions control the data processor to produce command signals based on the vehicle model to control the test rig to apply a combination of tire loads and positions to the tire and to feed back measured responses of the test rig to the vehicle model.

There are numerous potential benefits achieved with embodiments of the present invention. These include allowing tire testing to occur without the need to gather road data with a full vehicle. This permits earlier testing in the design process than otherwise possible.

Another benefit of the disclosed embodiments is that the test process need not reduce the tire characteristics to engineering terms of an implied tire model. This is because the real tire(s), with all of its un-modeled characteristics, interacts with the modeled vehicle as it would with a real vehicle. Also, because the tire interacts with the vehicle model through test rig feedbacks, changes in the tire characteristics will result in changes in applied load, as would happen on a real road. Thus results in more realistic tire testing. The effect of the tire on vehicle behavior is measured directly in the vehicle model, just as the more inconvenient road test measures tire/vehicle behavior directly.

Further, the effect of the vehicle model on the tire behavior may be measured directly with transducers on the test rig, just as the effect of the more inconvenient road test allows direct measurement of tire influenced behavior. It is also possible, with embodiments of the invention, to characterize the tire under conditions which represent those that would occur on the road, without the need for either a real vehicle or a real road, which may not be available at the time of measurement. The resulting characterization can be more representative than prior characterizations based on more traditional synthetic inputs, such as sinusoidal inputs.

Another benefit is that time consuming load history iteration compensations are rendered unnecessary by certain embodiments of the invention due to minimum tracking error characteristics of the test rig. Also, the set of all possible tires can be reduced to a smaller set for in-vehicle testing reducing track testing cost and time.

The ability to perform tire evaluation and tuning earlier in the design process avoids late cycle changes and impacts to dependent vehicle characteristics such as handling, NVH, durability, etc. Also, the embodiments of the invention provide the ability to assess tire design and manufacturing changes on the parameters of the vehicle with needing an actual full vehicle. This allows performance of tests, often at an earlier stage and at less cost, for handling, durability, safety, NVH and other tests without requiring a full vehicle. The embodiments of the invention also provide the ability to more accurately induce and capture the effects of tire wear.

An automobile includes various subsystems for performing different functions such as power train, driver interface, climate and entertainment, network and interface, lighting, safety, engine, braking, steering, chassis, etc. Each subsystem further includes components, parts and other subsystems. For instance, a power train subsystem includes a transmission controller, a continuously variable transmission (CVT) control, an automated manual transmission system, a transfer case, an all wheel drive (AWD) system, an electronic stability control system (ESC), a traction control system (TCS), etc. A chassis subsystem may include active dampers, magnetic active dampers, body control actuators, load leveling, anti-roll bars, etc. Designs and durability of these subsystems need to be tested and verified during the design and manufacturing process. Some of the subsystems use electronic control units (ECU) that actively monitor the driving condition of a vehicle and dynamically adjust the operations and/or characters of the subsystems, to provide better control or comfort. A full vehicle model needs to model, in some way, these subsystems.

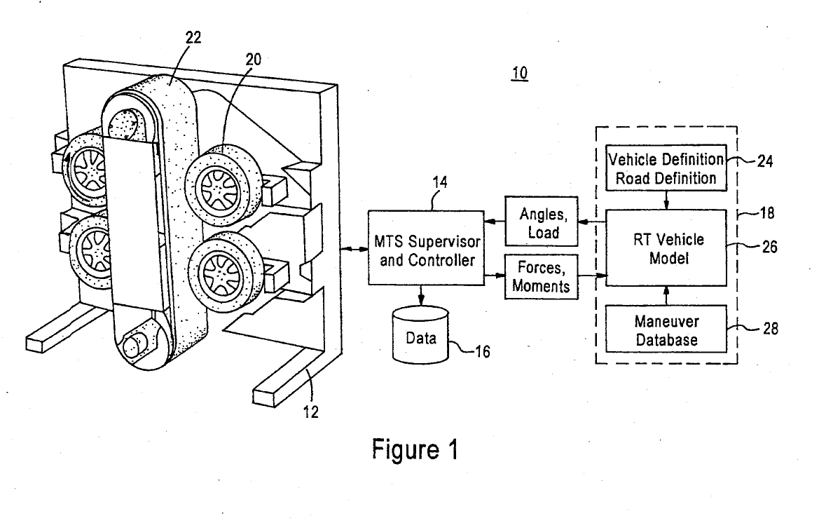

Certain embodiments of the present invention provide methods and systems to perform tire testing or evaluation by combining a full vehicle model, a road description and a test rig on which is mounted one or more physical tires. An exemplary embodiment of such a system 10 is depicted in FIG. 1.

The system 10 includes a test rig 12, a supervisor and controller (hereafter “supervisor”) 14, a data storage device 16, and a vehicle model module 18. In certain described exemplary embodiments, the vehicle model module 18 is implemented on a data processor that is separate from the data processor implementing the supervisor 14. In other exemplary embodiments, the supervisor 14 and vehicle model module are realized by a single data processor.

The configuration of the test rig 12 depicted in FIG. 1 is exemplary only, as other configurations and types of test rigs may be used without departing from the scope of the invention. The test rig 12 allows one or more tires 20 to be mounted for testing and evaluation. In the illustrated example, four tires 20 are mounted. Even more tires 20 can be mounted and tested on a test rig (not illustrated), for vehicles that have more than four tires. The test rig 12 of FIG. 1 includes a flat belt 22 that induces tire rotation to provide a simulated roadway. Other types of simulated roadways can be used, such as drums, etc. However, a flat roadway surface, such as the illustrated example, creates a more accurate tire contact patch simulation than is possible with a curved surface, such as with a drum-based roadway. In the embodiment of FIG. 1, the tires 20 are mounted on opposing sides of the flat belt 22. This offsets tire induced loads on the flat belt 22.

Among other options, various environmental effects can be simulated. For example, the test rig 12 may be located in a climate chamber (not shown) to control and/or capture the effects of heat, cold, humidity, moisture, dirt, salt or other environmental factors. Different roadway surface conditions may be simulated. For example, the flat belt 22 may be coated with a material to simulate the coefficient of friction of a real road using properties of the coating such as roughness, texture, etc. Certain methods of testing, according to other embodiments of the invention, apply water, snow, ice, dirt or dust to the flat belt 22 or other roadway surface, to control tire and roadway interactions, including, but not limited to, forces, moments, and thermal loading. In other embodiments, obstacles are affixed to the flat belt 22 to simulate curb or bump strikes. Obstacles may also be introduced by a mechanism that coordinates the obstacle with the roadway motion and with test control coordination. The temperature of the tire 20 is controlled in accordance with certain embodiments of the present invention, to simulate load-based heating of real driving conditions. In such embodiments, the set points can be input from a tire/vehicle model or a data file.

The road surface can be defined in a software model or measured and translated to software code, in different embodiments of the invention. The road definition can include such parameters as coefficient of friction, roughness, slop, curvature, bump or obstacle profiles, and temperature.

The test rig 12 includes a plurality of mounts that control the position and orientation of the tires 20, and the loads applied to the tires. For example, the following control parameters, as well as their translational or rotation equivalents, may be controlled. These include slip angle (steer), inclination angle (camber), loaded radius, normal force, wheel torque, slip ratio, longitudinal force, lateral force, etc. The method induces one or more of the other tire degrees of freedom, such as normal force, slip angle, inclination (camber) angle, slip ratio, wheel torque, loaded radius, inflation pressure, etc. Certain embodiments of the invention also induce one or more of the real degrees of freedom between the road and tire and wheel/spindle and body, through movement of the roadway or the spindle. Details of the mounting and force actuators of the test rig 12 are not depicted in FIG. 1.

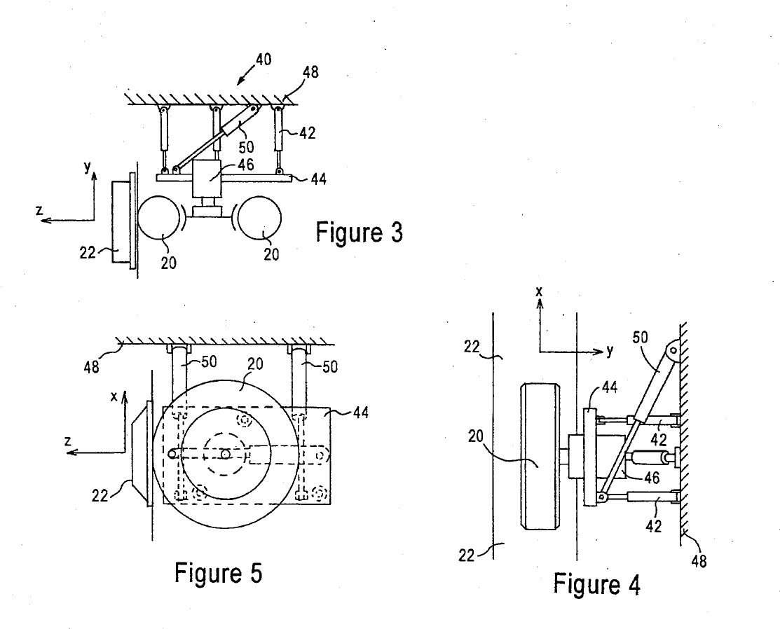

An exemplary embodiment of a mounting arrangement and tire positioner for the test rig 12 of FIG. 1 is depicted in FIGS. 3-5. A top view of a single tire mounting arrangement 40 (showing a cross-section of one of the tires 20) is depicted in FIG. 3.

FIG. 4 is a side view of the mounting arrangement of FIG. 3. FIG. 5 is a back view of the mounting arrangement of FIG. 3. This arrangement is exemplary only, as other configurations may be employed.

The mounting arrangement 40 positions the tire 20 against the flat belt 22. It provides for at least three degrees of freedom: vertical (z), slip angle (α), inclination angle (γ). Four actuators 42 are coupled to a plate 44 carrying a spindle 46 on which the tire 20 is mounted. The actuators 42 are coupled to the base 48 of the test rig 12. A pair of passive links 50 are provide between the base 48 and the plate 44. The tire 20 is free to rotate with the rotation of the spindle 46 in reaction to the movement of the flat belt 22.

The four actuators 42 control forces in the γ, α, y and z direction. The passive links 50 restrain spin rotation of the spindle housing and react forces in the x direction. The positioning of the tire 20, i.e., the angles and loading, are provided by the vehicle model module 18 to the supervisor 14. In turn, the supervisor 14 issues command signals to the test rig 12 to control the actuators 42 according to the angles and loading provided by the vehicle model module 18. A load cell (not shown) is provided in each of the links 42, 50, with signals indicating load measurements from the load cell representing measured forces and moments being provided back to the vehicle model 26 through the supervisor 14. Forces and moments may also be measured by a multi-axis load cell mounted on the spindle assembly.

Embodiments of the invention control the speed/torque of the roadway 22 and the tires 20 to simulate rotational slip, such as that induced by acceleration over a low coefficient friction surface, based on tire to road surface torque as calculated by the vehicle model module 18. A further ability provided in certain embodiments is to apply simulated spindle braking or accelerating torque-set points from a tire/vehicle model or a data file.

As stated earlier, embodiments of the invention perform tire testing, evaluation or tuning by combining a full vehicle model, a road description and a test rig on which is mounted one or more physical tires. To this end, a vehicle definition and road definition 24 are provided as inputs to a vehicle model 26 of the vehicle model module 18. A maneuver database 28 is also provided as an input to the vehicle model 26. Driver maneuvers are defined to excite required vehicle metrics that are influenced by tires. Driver behaviors may also be represented by, and included in, the full vehicle model.

The output of the vehicle model 26 is a combination of angles and loads that are to be applied to the tires 20. The supervisor 14 generates command signals based on this information to control the test rig 12, including, for example, the flat belt 12, the force actuators, tire orientation devices, etc. The supervisor 14 provides measured forces and moments received from the test rig 12 and inputs these into the vehicle model 26. The forces and moments can be measured at the test rig 12 by any suitable devices, such as load cells provided on different axes.

Some of the angles and loads provided by the vehicle model module 18 can include: body z, γ, road z(λ), road α(2), road v(2), steer, data. Some of the forces and moments measured at the test rig 12, provided as inputs to the vehicle model module 18, can include: body Fx Fy Fz, body Mx My Mz and axle z(2).

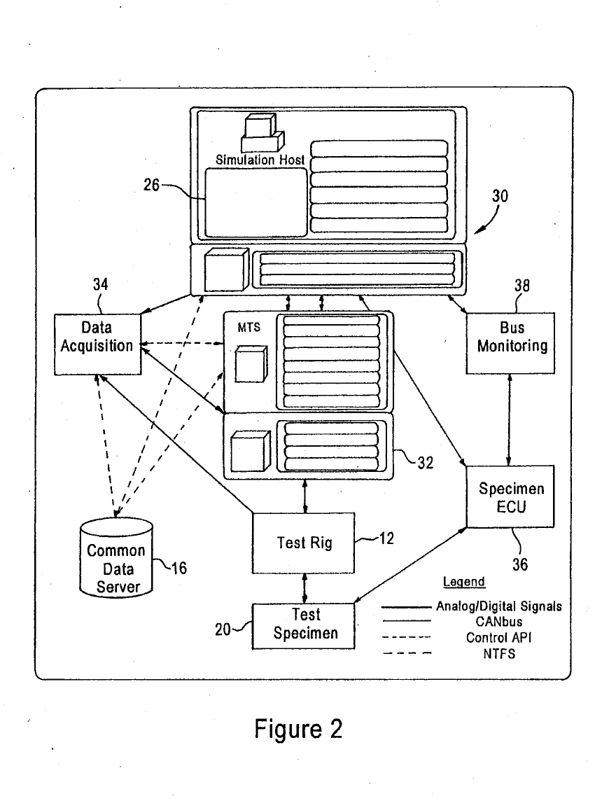

Embodiments of the invention combine a full vehicle model, a road description and a test rig with the physical tire. Modeling techniques are widely used and known to people skilled in the art. Companies supplying tools for building simulation models include Tesis, dSPACE, AMESim, The MathWorks. Companies that provide Hardware-in-the-loop simulators (HIL) include dSPACE, ETAS, Opal RT, A&D, etc. The full vehicle model 26 is executed in real time, in certain embodiments, by a separate data processor 30, as seen in FIG. 2. The full vehicle model 26 may include the following vehicle functions executed in real time: engine, powertrain, suspension, vehicle dynamics, tires, aerodynamics, driver, road. As stated earlier, at least one physical tire 20 is used in the testing, and this tire 20 is not in the model. However, other tires can be modeled if they are not physically present on the test rig 12. Hence, only a single physical tire 20 may be tested, with the other tires modeled in the full vehicle model 26. A convergence method is used in certain embodiments to determine tire effects on vehicle performance if other tires are not physically present based on iterative readings from the tires 20 that are physically present. The present tire is swapped by the software to various positions on the virtual vehicle in the full vehicle model 26. Iterative techniques are used to converge on a solution within defined error limits by using the real tire data or the simulation solution to populate tire models or determine vehicle response.

The context of the model is one which predicts the motion of the vehicle over the ground, given a driver's input of steering, throttle, brake and gear, as well as external disturbances such as aerodynamic forces. The model can be operated open loop with respect to the driver, replicating driver's inputs versus time. The model can be operated closed loop with respect to the driver if the driver's inputs are adjusted to maintain a speed and course of the vehicle.

The full vehicle model 26 is modified, as mentioned earlier, to remove the characteristic of the tire or tires 20 under test. The remainder of the full vehicle model 26 is provided with the output signal described above, in the form of displacements or loads that are transmitted as input signals to the test rig 12 to apply those same signals. The test rig 12 measured output signals in the form of complementary displacements or loads that become physical inputs to the full vehicle model 26 in place of the removed model of the tire or tires 20 under test. In this way, the physical tire or tires 20 under test is inserted into a real time model 26 of the full vehicle, road and driver.

Embodiments of the testing method of the present invention are conducted as on a real test track with either an open loop or closed loop driver. The test rig 12, working with the full vehicle model 26 and the suspension, applies loads to the tire or tires 20 in a manner that will be similar to the loads developed on a real road. The test rig 12 commands are not known in advance, so iteration techniques to develop modified load time histories may not be used. The test rig control is designed to produce minimum command tracking error. System identification techniques will achieve minimum tracking error.

FIGS. 1 and 2 depict only a single test rig 12 for testing tires. In other embodiments of the invention (not shown), other component test rigs, such as tires, damper, suspension, steering, etc., are linked to the system to assess multiple system mechanical and/or electronic and software integration in real time.

Referring to FIG. 2, the supervisor 14 is depicted as being provided by a second data processor 32, although the data processors 30 and 32 may be realized by a single data processor in certain embodiments. The software run by the data processor 32 coordinates the full vehicle model run by the data processor 30, the HIL (hardware in loop) system (if present) and the test rig 12. The system provides an automation method/sequence that can vary vehicle, component control software, driver model, or maneuver definitions to fine faults or search for local/global optimum settings as defined a list of target attributes. In certain embodiments, the full vehicle model 26 integrates with and simulates a vehicle electronics network. The tire or vehicle (electronic control units) ECUs may be included with or without HIL ECU test system to provide ECU vehicle parameters required to simulate in-vehicle operation.

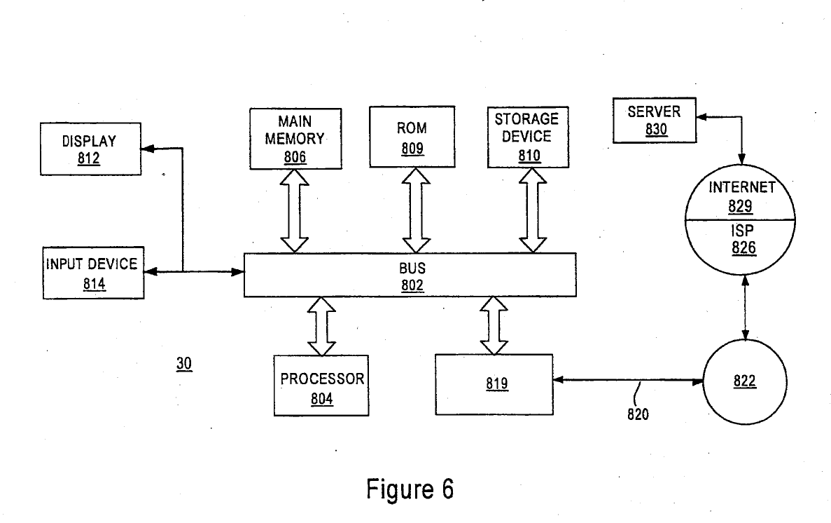

A more detailed description of an exemplary embodiment of a suitable data processor (30 or 32) is provided in FIG. 6, but FIG. 2 provides an overall view of the arrangement 10 and will be described. The simulation model 26 is run by the vehicle control module 18, which may be embodied, at least in part, by the data processor 30. In certain embodiments, the data processor 30 includes a plurality of modules for running the vehicle model. These include, for example, model optimization and mapping, customer simulation models, code generation, runtime tools and simulation visualization. The data processor performs real-time execution of simulation models, and includes a signal and communication interface.

The supervisor 14, embodied by the data processor 32, for example, also has a plurality of modules. These include rig system initialization, system setup, manual control, automated sequencing, subsystem management, system status, rig visualization, rig calibration, real-time degree of freedom control, data acquisition, signal management and safety management.

Data acquisition controller 34 acquires data signals from the test rig 12, and provides them to the data processor 32 of the supervisor 14. The data signals are produced by the load cells and position sensors (not shown). The data is output by the supervisor 14 to the data processor 30 for use in the vehicle model 26. Bus monitoring

An ECU 36 can be part of the evaluation process in certain embodiments, and be removed from the vehicle model 26, as is the case for the tire or tires 20. The ECU 36 under test may be part of an active suspension system, for example, or some other system. Bus monitoring may be performed by a bus monitor 38.

Methods of the present invention reduce real-time test rig control lag, and compensate for test rig sensors as necessary. Sensor signals are communicated to the vehicle model with minimal lag to permit stable operation of the model. Data from the full vehicle model 26 can be captured and stored to serve as experimental results. Similarly, data from the tire 20 can be captured and stored to serve as experimental results.

FIG. 6 is a block diagram that illustrates an exemplary embodiment of the data processing system 30 upon which a real-time full vehicle simulation model 26 may be implemented by the vehicle model module 18. A similar data processing system may be employed for the data processing system comprising the supervisor 14. Data processing system 30 includes a bus 802 or other communication mechanism for communicating information, and a processor 804 coupled with bus 802 for processing information. Data processing system 30 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Data processing system 30 further includes a read only memory (ROM) 809 or other static storage device coupled to bus 802 for storing static information and instructions for processor 804. A storage device 810, such as a magnetic disk or optical disk, is provided and coupled to bus 802 for storing information and instructions. In certain embodiments, the data storage device 810 comprises the storage device 16.

Data processing system 30 may be coupled via bus 802 to a display 812, such as a cathode ray tube (CRT), for displaying information to an operator. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812.

The data processing system 30 is controlled in response to processor 804 executing one or more sequences of one or more instructions contained in main memory 806. Such instructions may be read into main memory 806 from another machine-readable medium, such as storage device 810 (16). Execution of the sequences of instructions contained in main memory 806 causes processor 804 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810 (16). Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 804 for execution. For example, the instructions may initially be carried on a magnetic disk of a remote data processing system. The remote data processing system can load the instructions into its dynamic memory and send the instructions over a telephone line using a modem. A modem local to data processing system 30 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 (16) either before or after execution by processor 804.

Data processing system 30 also includes a communication interface 819 coupled to bus 802. Communication interface 819 provides a two-way data communication coupling to a network link that is connected to a local network 822. For example, communication interface 819 may be an integrated services digital network (ISDN) card or a modem to provide a data communication connection to a corresponding type of telephone line. As another example, communication interface 819 may be a local area network (LAN) card to provide a data communication connection to a compatible LAN. Wireless links may also be implemented. In any such implementation, communication interface 819 sends and receives electrical, electromagnetic or optical signals that carry digital data streams representing various types of information.

The network link 820 typically provides data communication through one or more networks to other data devices. For example, the network link 820 may provide a connection through local network 822 to a host data processing system or to data equipment operated by an Internet Service Provider (ISP) 826. ISP 826 in turn provides data communication services through the world wide packet data communication network now commonly referred to as the “Internet” 829. Local network 822 and Internet 829 both use electrical, electromagnetic or optical signals that carry digital data streams. The signals through the various networks and the signals on network link 820 and through communication interface 819, which carry the digital data to and from data processing system 30, are exemplary forms of carrier waves transporting the information.

Data processing system 30 can send messages and receive data, including program code, through the network(s), network link 820 and communication interface 819. In the Internet example, a server 830 might transmit a requested code for an application program through Internet 829, ISP 826, local network 822 and communication interface 819.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

The embodiments of the present invention therefore provide improved methods and systems for tire evaluation and tuning by employing a combination of a full vehicle model, a road description and a test rig with at least one physical tire. Tire testing can occur without the need to gather road data with a full vehicle, allowing earlier testing than otherwise possible. The tire can be characterized under conditions which represent those that would occur on a road, without the need for either a real vehicle or a real road. Since the tire interacts with the vehicle model through test rig feedback, changes in the tire characteristics will result in changes in applied load, as will happen on a real road, thereby resulting in more realistic testing. The embodiments of the invention do not require reduction of tire characteristics to engineering terms of an implied tire model, since a real tire with all of its un-modeled characteristics interacts with the modeled vehicle as it would with a real vehicle.

The disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than a restrictive sense.

What is claimed is:

1. A system for characterizing and or evaluating tires and or conducting numerical vehicle simulations, comprising:
a test rig on which at least one tire under test is mountable, the test rig controllably imposing forces and motions on the tire under test; and
a vehicle model module that includes:
a data processor for processing data; and
a data storage device configured to store: data related to a vehicle model that simulates a full vehicle except for characteristics of the tire under test; data related to a road description; data related to maneuvers and/or driver behaviors; test rig parameters, controller parameters, test data . . . and machine-executable instructions, wherein the instructions, upon execution by the data processor, control the vehicle model module to produce command signals based on the vehicle model and the road description to control the test rig to apply loads on the tire and to feed back measured responses of the test rig to the vehicle model.

2. The system of claim 1, further comprising a supervisor coupled to the vehicle model module and to the test rig, the supervisor comprising a data processor configured to coordinate the vehicle model and the test rig, provide the command signals to the test rig and provide the measured responses to the vehicle model.

3. The system of claim 1, wherein the human driver component of the vehicle model is configured to operate open loop with respect to a driver by replicating driver inputs versus time.

4. The system of claim 1, wherein the human driver component of the vehicle model is configured to operate closed loop with respect to a driver by adjusting driver inputs so as to maintain a speed and a course of the full vehicle.

5. The system of claim 1, wherein the full vehicle model includes modeling of: engine; powertrain, suspension, vehicle dynamics, aerodynamics, driver and road.

6. The system of claim 5, wherein the full vehicle model includes modeling of tires that are not physically present in the test rig.

7. The system of claim 6, wherein the modeling of tires includes a converging iterative process to virtually move the tire under test to different position on the vehicle model.

8. The system of claim 1, wherein the test rig includes a simulated roadway that contacts and induces rotation of the tire under test during operation.

9. The system of claim 8, wherein the simulated roadway is a flat belt on an endless loop.

10. The system of claim 9, wherein a plurality of tires are simultaneously tested, and wherein the tires are positioned on opposing sides of the roadway loop.

11. The system of claim 10, wherein the data related to the road description includes roadway surface definition including at least one of the parameters: coefficient of friction, roughness, slope, curvature, obstacle profiles, bump profiles and temperature.

12. The system of claim 8, wherein the command signals include control of speed of the simulated roadway for simulating longitudinal slip.

13. The system of claim 1, wherein physical obstacles are passed between the roadway and tire.

14. The system of claim 2, wherein the supervisor and the vehicle model module are configured for coupling to different component test rigs for other vehicle components to interact with the different component test rigs and integrating in the vehicle model results from the different component test rigs and the test rig on which the tire under test is mounted.

15. A method of evaluating tires, comprising:
mounting at least one tire on a test rig;
inducing rotation of the tire with a simulated roadway on the test rig;
modeling a full vehicle model excluding the tire on the test rig;
predicting motion of the vehicle model over a road;
generating command signals to the test rig based on the vehicle model and the predicted motion as at least one set of velocity, displacement and load control signals;
applying velocity, forces and displacements to the tire with the test rig in accordance with the command signals;
measuring at least one of complementary displacements and loads of the tire at the test rig; and
providing the measured complementary displacements and loads to the vehicle model.

16. The method of claim 15, wherein the full vehicle model is executed substantially in real time.

17. The method of claim 16, wherein a plurality of physical tires of a vehicle mounted on the test rig and simultaneously evaluated.

18. The method of claim 16, wherein the simulated roadway is a flat belt.

19. The method of claim 18, further comprising changing the physical conditions of the simulated roadway.

20. The method of claim 19, wherein the step of changing the physical conditions of the roadway include at least one of: coating a roadway surface to simulate the coefficient of friction of a physical road; applying water, snow, ice or dirt to the roadway surface; passing obstacles between the roadway and tire; and affixing obstacles to the roadway surface.

21. The method of claim 16, further comprising controlling the speed of the simulated roadway so as to simulate longitudinal slip based on tire to road surface torque as determined by the full vehicle model.

22. The method of claim 16, further comprising simultaneously controlling a plurality of test rigs on which tires are mounted.

23. The method of claim 16, further comprising controlling inputs to test rigs on which are mounted physical vehicle components other than tires, and receiving outputs from the test rigs and providing the outputs to the vehicle model.

24. The method of claim 16, further comprising subjecting the tire to environmental effects.

25. The method of claim 16, further comprising controlling the temperature of the tire to simulate load-based thermal loads.

26. The method of claim 16, wherein the tire is mounted on a spindle on the test rig, and further controlling the simulated roadway and the loads applied to the tire to induce one or more real degrees of freedom between the simulated roadway and the tire through movement of the roadway.

27. The method of claim 26, further comprising controlling the simulated roadway and the loads applied to the tire to induce one or more tire degrees of freedom including at least one of normal force, slip angle, inclination angle, slip ratio, wheel torque, loaded radius and inflation pressure.

28. The method of claim 16, further comprising controlling the simulated roadway and the loads applied to the tire to simulate spindle braking or accelerating torque.
